(19) United States
(12) Patent Application Publication
(10) Pub. No.: US 2007/0161419 A1
(43) Pub. Date: Jul. 12, 2007

(54) Mobile telephone device

(76) Inventor: Yujiro Dakeya, Omihachiman-shi (JP)

Correspondence Address: DICKSTEIN SHAPIRO LLP, 1177 AVENUE OF THE AMERICAS (6TH AVENUE), NEW YORK, NY, 10036-2714, US

(21) Appl. No.: 11/602,319

(22) Filed: Nov. 21, 2006

Related U.S. Application Data
(63) Continuation of application No. PCT/JP05/02849, filed on Feb. 23, 2005.

(30) Foreign Application Priority Data
May 21, 2004 (JP) JP2004-151596

(51) Int. Cl. H04M 1/00

(52) U.S. Cl. 455/575.7; 455/575.3

(57) ABSTRACT

A mobile telephone device includes a display casing having display panels and a television antenna unit, an operation casing having an operation unit and a mobile telephone device antenna unit, and a hinge unit for rotatably connecting the display casing to the operation casing. The television antenna unit is provided at the end of the display casing opposite the end having the hinge unit. The mobile telephone device antenna unit is provided at the end of the operation casing on the hinge unit side. Therefore, the antennas are always separated by the length of the display casing. In addition, a ground electrode is formed so as to continuously extend on the display casing and the operation casing. One end of the television antenna unit electrically communicates with this ground electrode. Thus, a ground electrode having a length corresponding to the television antenna unit can be provided.

### CROSS REFERENCE TO RELATED APPLICATIONS

The present application is a continuation of International Application No. PCT/JP2005/002849, filed Feb. 23, 2005, which claims priority to Japanese Patent Application No. JP2004-151596, filed, May 21, 2004, the entire contents of each of these applications being incorporated herein by reference in their entirety.

### FIELD OF THE INVENTION

The present invention relates to a mobile telephone device capable of receiving a digital television broadcast, which is known as a mobile telephone device with a television receiver.

### BACKGROUND OF THE INVENTION

In general, mobile telephone devices capable of receiving a digital television broadcast (hereinafter simply referred to as “mobile telephone devices with a television receiver”) include two types of antenna: an antenna for receiving digital television broadcast signals (hereinafter simply referred to as a “television reception antenna”) and an antenna for transmitting and receiving mobile-phone communication signals (hereinafter simply referred to as a “mobile telephone device antenna”), because the frequency range of the digital television broadcast signals (470 MHz to 770 MHz) is different from the frequency range of the mobile-phone communication signals (800 MHz band). Since the frequency range of the digital television broadcast signals is wide, a plurality of antenna lengths are required in order to receive the signals over such a wide frequency range efficiently. Accordingly, many configurations that provide the plurality of antenna lengths are proposed (refer to, for example, Patent Document 1 and Patent Document 2).

The antenna described in Patent Document 1 includes a plurality of antenna cores having different magnetic permeability. One of the antenna cores is selected and used depending on the desired frequency range. In contrast, an apparatus described in Patent Document 2 uses a rod antenna extending from a casing of the apparatus to the outside and a passive component disposed in the casing. For example, the apparatus selects whether the apparatus uses the passive component or changes the characteristic value of the passive component so as to change the reception frequency range for obtaining high gain.

[Patent Document 1] Japanese Unexamined Patent Application Publication No. 2003-142928

[Patent Document 2] Japanese Unexamined Patent Application Publication No. 2001-339329

However, since, in recent years, the size of a mobile telephone device has been reduced, the distance between the mounting position of a television reception antenna and the mounting position of a mobile telephone device antenna has tended to decrease. Accordingly, mutual interference occurs between these antennas, and therefore, the reception of digital television broadcast signals and the transmission and reception of mobile telephone communication signals could be disturbed. Additionally, although the used frequency of the digital television broadcast signals is higher than that of analog television broadcast signals, the lowest used frequency (about 470 MHz) is about half the frequency of the mobile telephone communication signals (about 800 MHz). Accordingly, to receive the digital television broadcast signals efficiently, a ground length (which is a factor in determining the antenna length) about twice the antenna length is needed. It is difficult for the mobile telephone device having a reduced size to accommodate a ground electrode having such a length.

### SUMMARY OF THE INVENTION

Accordingly, it is an object of the present invention to provide a mobile telephone device that can reduce the mutual interference between the television antenna and the mobile telephone device antenna and efficiently receive digital television broadcast signals.

The present invention provides a foldable mobile telephone device including a first casing including displaying means, a second casing including operating means, a hinge for rotatably connecting the first casing to the second casing, a first antenna mounted at an end of the first casing opposite an end adjacent to the hinge, where the first antenna receives a television broadcast signal, a second antenna mounted on the second casing, where the second antenna transmits and receives a mobile phone communication signal, and a ground electrode formed so as to continuously extend from the end of the first casing on the first antenna side to the end of the second casing opposite the end adjacent to the hinge.

More specifically, the mobile telephone device according to the present invention defines a signal in the first frequency range as a television broadcast signal. In addition, the mobile telephone device defines a signal in the second frequency range as a mobile telephone communication signal. The mobile telephone device transmits and receives the mobile telephone communication signal using the second antenna.

In such a configuration, the mobile telephone device is unfolded when a television broadcast is received. Accordingly, the first antenna used for receiving the television broadcast signals is separated from the second antenna used for transmitting and receiving the mobile telephone communication signal by at least the length of the first casing. Thus, the mutual interference between the first antenna and the second antenna is reduced. In addition, the ground electrode is formed so as to extend from the end of the first casing on the first antenna side to the end of the second casing opposite the end of the second casing on the hinge side, that is, across substantially the entire length of the mobile telephone device. Accordingly, the ground electrode having a sufficient length for the first antenna that receives the television broadcast signals having a wavelength greater than that of the mobile telephone communication signals can be provided. Thus, the television broadcast signals can be received by this ground electrode as well.

According to the present invention, the first antenna can include a linear conductor antenna outwardly extending from the end of the first casing on the first antenna side and a chip antenna disposed inside the first casing and electrically communicating with the linear conductor antenna.

In such a structure, since the first antenna includes the linear conductor antenna and the chip antenna and these different types of antenna receive the television broadcast signals, the performance of the first antenna can be improved. In addition, since the plurality of antennas together provide a required antenna length, the length of the linear conductor antenna can be decreased by using the chip antenna.

According to the present invention, the linear conductor antenna can be rotatably mounted on the first casing.

In such a structure, when the television broadcast signals are being received, the linear conductor antenna is rotated from being disposed along the end surface of the first casing on which the linear conductor antenna is mounted (the top end surface of the mobile telephone device) to the outside so as to be directed in the vertical direction. When the television broadcast signals are not being received, the linear conductor antenna is rotated so as to be disposed along the end surface of the first casing on which the linear conductor antenna is mounted or is rotated from being disposed along the end surface of the first casing on which the linear conductor antenna is mounted (the top end surface of the mobile telephone device) to inside the mobile telephone device so as to be directed in the vertical direction. Accordingly, when the mobile telephone device is being used, the linear conductor antenna effectively functions as part of an antenna for receiving a television broadcast signal. When the mobile telephone device is not being used, the linear conductor antenna does not extend beyond the outline of the mobile telephone device. Therefore, the mobile telephone device can maintain the compact size thereof.

According to the present invention, the first antenna can include a plate conductor antenna disposed inside the first casing and a chip antenna electrically communicating with the plate conductor antenna.

In such a structure, since the first antenna is entirely mounted inside the first casing, the mobile telephone device can be of small size. In addition, since the first antenna includes the plate conductor antenna and the chip antenna, the television broadcast signals can be efficiently received compared with the case where only the chip antenna is used.

According to the present invention, the plate conductor antenna can be bonded to an inner surface of the first casing.

In such a structure, since the plate conductor antenna is bonded to an inner surface of the first casing, the plate conductor antenna does not require an area of the board in the first casing in which the plate conductor antenna is to be mounted. Accordingly, by mounting the chip antenna in this area, the required antenna mounting area is not increased.

According to the present invention, the first antenna can include antenna length selecting means for selectively changing the effective antenna length.

In such a structure, since the antenna length of the first antenna is changeable, a plurality of resonance frequencies can be set for the television broadcast signals having a wide frequency range. Accordingly, the resonance frequency can be changed depending on the frequency of the received television broadcast signal.

According to the present invention, the first antenna is removably disposed on the first casing.

In such a structure, since the first antenna can be mounted only when the mobile telephone receives the television broadcast signals, the mutual interference does not occur when the mobile telephone transmits and receives mobile telephone communication signals.

According to the present invention, the second antenna can be disposed at the end of the second casing on the hinge side.

In such a structure, since the second antenna is disposed at the end of the second casing on the hinge side, the distance between the first antenna and the second antenna is equal to the length of the first casing in either case where the mobile telephone device is unfolded or folded. Accordingly, mutual interference between these antennas can be reduced.

According to the present invention, the second antenna can be disposed at the end of the second casing opposite the end on the hinge side.

In such a structure, since the distance between the first antenna and the second antenna is equal to the entire length of the mobile telephone device when the mobile telephone device is unfolded, the mutual interference between these antennas is further reduced.

According to the present invention, the chip antenna can include a base formed from at least one of a dielectric material and a magnetic material, a power feeding conductor formed at least one of in the base and on the base, and a power feeding terminal for feeding electric power to the electric power feeding conductor.

In such a structure, the chip antenna having a compact size can be formed compared with the linear conductor antenna or the plate conductor antenna. In addition, since the chip antenna can be mounted on the mounting board in the first casing, the size of the first antenna can be reduced without decreasing the transmission/reception characteristics.

According to the present invention, the antenna length selecting means can include a switching element connected between one end of the chip antenna and a signal output unit and a passive component connected between the other end of the chip antenna and the signal output unit.

In such a structure, since the antenna length is changed by only the switching element, the chip antenna, and the passive component, the antenna length can be changed by using a simplified configuration and a simplified control method.

According to the present invention, the passive component includes an inductor or a capacitor.

In such a configuration, since the passive component includes a simplified component, such as an inductor or a capacitor, furthermore, the mobile telephone device having the above-described characteristics can have a simplified structure.

According to the present invention, the first antenna receives television broadcast signals having a frequency range lower than that of the mobile telephone communication signals. The second antenna transmits and receives the mobile telephone communication signals. The first antenna is separated from the second antenna by at least the length of the first casing. Accordingly, mutual interference between the first antenna and the second antenna can be reduced. Thus, the reception characteristics of the first antenna can be improved when the television broadcast signals are being received.

Furthermore, the ground electrode is formed from the end of the first casing on the first antenna side to the end of the second casing opposite the end of the second casing on the hinge side. Accordingly, the ground electrode having a sufficient length for the first antenna can be provided. Thus, the television broadcast signals can be received by this ground electrode as well, and therefore, the reception characteristics of the first antenna can be further improved when the television broadcast signals are being received.

In addition, according to the present invention, since the first antenna for receiving television broadcast signals includes the linear conductor antenna protruding from the first casing outwardly and a chip antenna disposed in the first casing, the reception characteristics can be improved compared with the case where only the linear conductor antenna is used. Furthermore, to obtain the required antenna length, the length of the linear conductor antenna can be decreased by the length of the chip antenna. Accordingly, the entire length of the mobile telephone device can be reduced when the mobile telephone device receives the television broadcast signals.

In addition, according to the present invention, since the linear conductor antenna is rotatable, the linear conductor antenna can be protruded outwardly from the first casing when being used. In contrast, when not being used, the linear conductor antenna can be accommodated within the external length of the first casing. Thus, the mobile telephone device can be of reduced size without sacrificing the reception characteristic when being used.

In addition, according to the present invention, by replacing the linear conductor antenna with a plate conductor antenna, the first antenna for receiving television broadcast signals can be entirely accommodated in the first casing. Accordingly, the size of the mobile telephone device can be reduced.

In addition, according to the present invention, since the plate conductor antenna can be bonded to the inner surface of the first casing, an area of the board in which surface-mounted components are mounted can be provided. Accordingly, the required space in the first casing can be reduced, and therefore, the size of the mobile telephone device can be further reduced.

In addition, according to the present invention, the resonance frequency of the antenna can be changed in accordance with the frequency of the received television broadcast signal. Accordingly, the mobile telephone device can efficiently receive the television broadcast signals over the entire wide frequency range.

In addition, according to the present invention, since the first antenna for receiving television broadcast signals is removable, the first antenna can be mounted as needed. Thus, the mutual interference does not occur when a mobile telephone communication signal is received, and therefore, the mobile telephone device can efficiently transmit and receive mobile telephone communication signals.

In addition, according to the present invention, in either case where the mobile telephone device is unfolded or folded, the distance between the first antenna and the second antenna is equal to the length of the first casing. Accordingly, mutual interference between these antennas can be reduced. In either a standby mode or a call mode, the mobile telephone device can efficiently transmit and receive mobile telephone communication signals.

In addition, according to the present invention, when the mobile telephone device is unfolded, the distance between the first antenna and the second antenna is equal to the entire length of the mobile telephone device and the mutual interference between the antennas is further reduced. Accordingly, when the mobile telephone device receives television broadcast signals and the mobile telephone device receives and transmits mobile telephone signals, the mobile telephone device can efficiently receive and transmit these signals.

### BRIEF DESCRIPTION OF THE DRAWINGS

FIG. 1 is an external view of a mobile telephone device according to a first embodiment.

FIG. 2 illustrates the structure of a television antenna unit 4 of the mobile telephone device according to the first embodiment.

FIG. 3 illustrates circuit diagrams of the television antenna unit 4 when the DC control voltage is applied and when the DC control voltage is not applied.

FIG. 4 illustrates graphs of the VSWR characteristic and the gain characteristic and the Smith chart when a diode D48 of the mobile telephone device according to the first embodiment is in an off state.

FIG. 5 is a diagram illustrating the directivity of the radiation electric field strength when the diode D48 of the mobile telephone device according to the first embodiment is in an off state.

FIG. 6 illustrates graphs of the VSWR characteristic and the gain characteristic and the Smith chart when the diode D48 of the mobile telephone device according to the first embodiment is in an on state.

FIG. 7 is a diagram illustrating the directivity of the radiation electric field strength when the diode D48 of the mobile telephone device according to the first embodiment is in an on state.

FIG. 8 is an external view of a mobile telephone device according to a second embodiment.

FIG. 9 is an external view of a mobile telephone device according to a third embodiment.

FIG. 10 is an external view of a mobile telephone device according to a fourth embodiment.

FIG. 11 is a circuit diagram of a television antenna unit 4 of the mobile telephone device according to the fourth embodiment.

FIG. 12 is an external view of a mobile telephone device according to a fifth embodiment.

FIG. 13 is an exploded view of the structure of the mobile telephone device according to the fifth embodiment.

### REFERENCE NUMERALS

1 display casing

10A main display panel

10B sub display panel

101 board

111 ground electrode of board 101

2 operation casing

20 operation unit

102 board

112 ground electrode of board 102

3 hinge unit

113 flat cable

4 television antenna unit

5 mobile telephone device antenna unit

6 television antenna member

ANT41 rod antenna

ANT42, 43, 52 chip antenna

ANT51 plate antenna

### DETAILED DESCRIPTION OF THE INVENTION

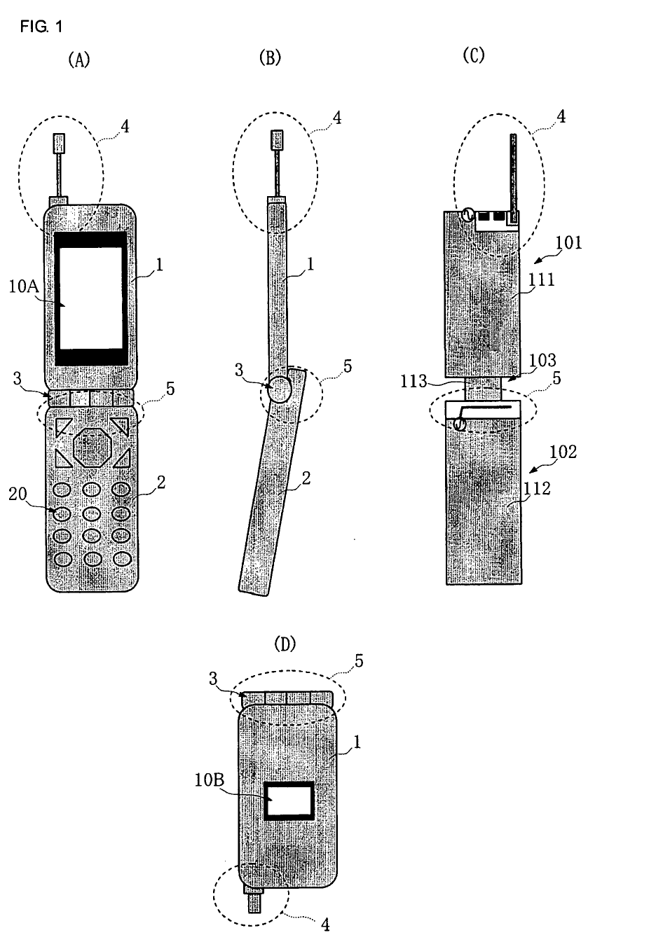

A mobile telephone device with a television receiver according to a first embodiment of the present invention is described below with reference to FIGS. 1 to 7.

FIG. 1 is an external view of the mobile telephone device according to the present embodiment, where FIG. 1(A) is a front view of the mobile telephone device in an open configuration, FIG. 1(B) is a side view of the mobile telephone device in an open configuration, FIG. 1(C) is a front view of a board in a casing of the mobile telephone device in an open configuration, and FIG. 1(D) is a front view of the mobile telephone device in a closed configuration.

As shown in FIG. 1, the mobile telephone device with a television receiver according to the present embodiment includes a display casing 1 having a main display panel 10A on one of the main surfaces thereof and a sub display panel 10B on the opposite main surface, an operation casing 2 having an operation unit 20 with a plurality of buttons on one of the main surfaces thereof, and a hinge unit 3 that rotatably connects the display casing 1 to the operation casing 2. The display casing 1 and the operation casing 2 are rotatably fixed so that the surface having the main display panel 10A of the display casing 1 faces the surface having the operation unit 20 of the operation casing 2. In a closed configuration of the mobile telephone device (see FIG. 1(D)), these surfaces closely face each other. In an open configuration of the mobile telephone device (see FIG. 1(A)), these surfaces are rotatably fixed so as to face substantially the same direction.

The display casing 1 that includes the main display panel 10A and the sub display panel 10B further includes a board 101 having a panel control circuit and a main control circuit (neither is shown) mounted thereon. The panel control circuit controls these display panels. The main control circuit performs overall control of the mobile telephone device. A television antenna unit 4 having a predetermined effective antenna length is formed at the end of the board 101 opposite the end having the hinge 3. As described below, the television antenna unit 4 virtually functions as an antenna having two lengths by means of a DC control voltage. One of the two antenna lengths is a substantially ¼ wavelength of the desired high frequency. The other is a substantially ¼ wavelength of the desired low frequency. A ground electrode 111 having a predetermined pattern is formed on the board 101 so as to extend along the length direction of the board 101, that is, from the end at which the television antenna unit 4 is mounted to the end at which the hinge unit 3 is mounted.

The operation casing 2 that includes the operation unit 20 further includes a board 102 having an operation control circuit and a power supply circuit (neither is shown) mounted thereon. The operation control circuit controls the operation unit 20. A mobile telephone device antenna unit 5 is formed at the end of the board 102 adjacent to the hinge 3. The mobile telephone device antenna unit 5 has an effective antenna length of a substantially ¼ wavelength of the frequency of the mobile telephone communication signal. Additionally, a ground electrode 112 having a predetermined pattern is formed on the board 102 so as to extend along the length direction of the board 102, that is, from the end adjacent to the hinge unit 3 at which the mobile telephone device antenna unit 5 is mounted to the end opposite that end.

The hinge unit 3 includes a flat cable 103 for connecting a circuit electrode on the board 101 included in the display casing 1 to a circuit electrode on the board 102 included in the operation casing 2. The flat cable 103 allows the control circuits mounted on the board 101 to electrically communicate with the control circuits mounted on the board 102. The flat cable 103 also allows the ground electrode 111 of the board 101 to electrically communicate with the ground electrode 112 of the board 102.

Here, the display casing 1 corresponds to a “first casing” of the present invention while the operation casing 2 corresponds to a “second casing” of the present invention. The television antenna unit 4 corresponds to a “first antenna” of the present invention while the mobile telephone device antenna unit 5 corresponds to a “second antenna” of the present invention.

In such a mobile telephone device with a television receiver, when the body is unfolded, that is, when the display casing 1 is rotated so that the operation surface is exposed and the mobile telephone device function is operated via the operation unit 20, the main display panel 10A displays the information corresponding to that operation. At that time, mobile telephone communication signals are transmitted and received via the mobile telephone device antenna unit 5. In contrast, when the body is unfolded and the television receiver function is operated via the operation unit 20, the television antenna unit 4 receives television broadcast signals in response to that operation and the main display panel 10A displays images obtained by playing back a received television broadcast program.

In the present embodiment, as noted above, since the television antenna unit 4 is separated from the mobile telephone device antenna unit 5 by the length of the display casing 1, the mutual interference therebetween is prevented. Thus, while television broadcast signals are received, the television broadcast signals can be efficiently received. In addition, while mobile telephone communication signals are being received, the mobile telephone communication signals can be efficiently received. Furthermore, since the ground electrode is formed so as to extend along substantially the entire length of the mobile telephone device from the display casing 1 to the operation casing 2, the sufficient length of the ground electrode for the television antenna unit 4 can be obtained. Therefore, the television broadcast signals can be efficiently received by the ground electrode as well. As a result, furthermore, the mobile telephone device can receive the television broadcast signals efficiently. In addition, even when the body is in a closed configuration, the antennas are separated from each other by the length of the display casing 1. Therefore, the mutual interference therebetween is prevented when the mobile telephone device is in a standby mode. Thus, the mobile telephone device can efficiently receive a call signal.

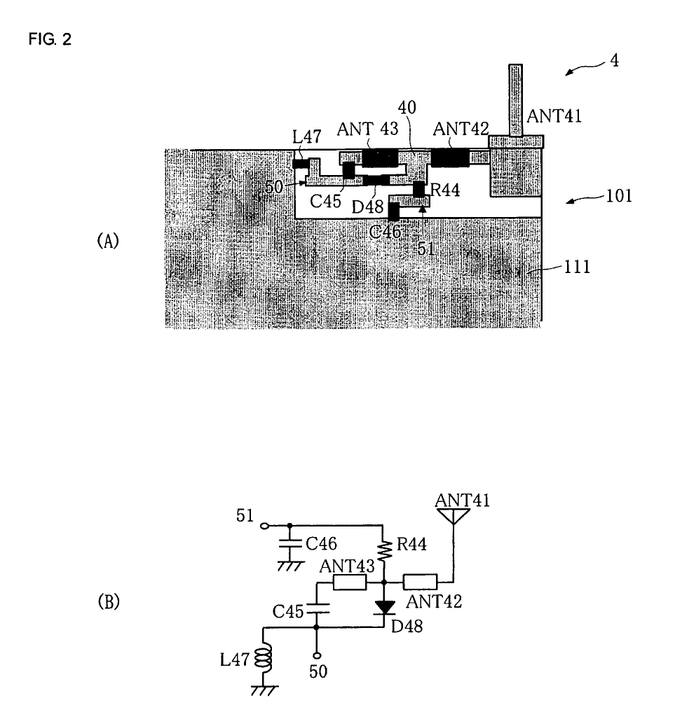

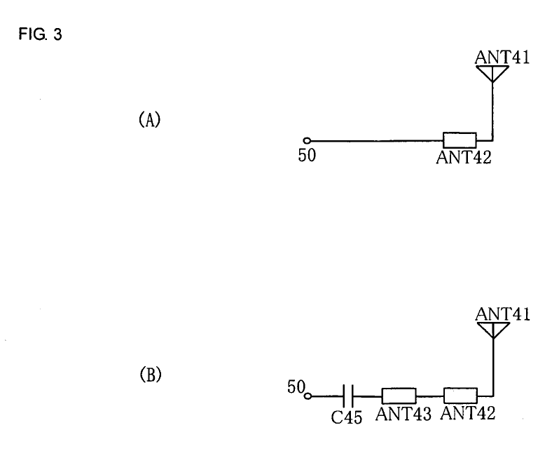

An exemplary structure of the television antenna unit 4 is described next with reference to FIGS. 2 and 3.

FIG. 2 illustrates the structure of the television antenna unit 4, where FIG. 2(A) is a plan view illustrating the structure of the television antenna unit 4 and FIG. 2(B) is a circuit diagram of the television antenna unit 4.

FIG. 3 illustrates circuits of the television antenna unit 4 when the DC control voltage is applied and when the DC control voltage is not applied, where FIG. 3(A) is the circuit when the DC control voltage is applied and FIG. 3(B) is the circuit when the DC control voltage is not applied.

As shown in FIG. 2(A), the television antenna unit 4 includes a rod antenna ANT41 mounted at one of the corners of the end of the board 101 on the side opposite to the hinge unit 3 and extending from the board 101 outwardly (in a direction away from the hinge unit 3), chip antennas ANT42 and ANT43 disposed along the side surface of the board 101 opposite the hinge unit 3, a chip resistor R44 disposed in the vicinity of the rod antenna ANT41 and the chip antennas ANT42 and ANT43, chip capacitors C45 and C46, a chip coil L47, and a chip diode D48. These elements and a circuit pattern 40 form a circuit equivalent to the circuit shown in FIG. 2(B). Here, the rod antenna ANT41 corresponds to a “linear conductor antenna” of the present invention.

The rod antenna ANT41 is connected to one end of the chip antenna ANT42. The other end of the chip antenna ANT42 is connected to one end of the chip antenna ANT43. The other end of the chip antenna ANT43 is connected to a feed point 50 via the chip capacitor C45, that is, is connected to an output terminal of the television broadcast signal. Additionally, the one end of the chip antenna ANT43 (i.e., the connection point between the chip antenna ANT43 and the chip antenna ANT42) is connected to the feed point 50 via the chip diode D48 and is also connected to a DC applied terminal 51 via the chip resistor R44. Furthermore, the feed point 50 is connected to the ground electrode 111 via the chip coil L47. The DC applied terminal 51 is connected to the ground electrode 111 via the chip capacitor C46. Here, the chip antennas ANT42 and ANT43 are formed as chip helical antennas. The term chip helical antenna refers to an antenna having a substantially rectangular shape and including a base formed from at least one of a dielectric material and a magnetic material, a helical conductor formed on the surface of the base or inside the base, and an electrode terminal formed on the surface of the base and electrically communicating with the conductor.

As shown in FIG. 3, the television antenna unit 4 having such a structure exhibits two characteristics: one in the state in which the DC control voltage is applied to the DC applied terminal 51 and the other in the state in which the DC control voltage is not applied to the DC applied terminal 51.

When the DC control voltage is applied, the chip diode D48 is in a short-circuit state. Thus, a series circuit of the rod antenna ANT41 and the chip antenna ANT42 is connected to the feed point 50. That is, the circuit formed from the chip antenna ANT43 and the chip capacitor C45 does not function, and therefore, only part of the circuit formed from the rod antenna ANT41 and the chip antenna ANT42 functions as a television antenna. That is, the antenna length is determined by the part of the circuit formed by the rod antenna ANT41 and the chip antenna ANT42. In contrast, when the DC control voltage is not applied, the chip diode D48 is open. Accordingly, a series circuit of the rod antenna ANT41, the chip antenna ANT42, and the chip antenna ANT43 is virtually connected to the feed point 50 via the chip capacitor C45. That is, part of circuit formed from the rod antenna ANT41, the chip antenna ANT42, and the chip antenna ANT43 functions as a television antenna. That is, the antenna length is determined by the part of the circuit formed from the rod antenna ANT41 and the chip antennas ANT42 and ANT43. Accordingly, by applying the DC control voltage, the antenna length is decreased by the antenna length of the chip antenna ANT43 compared with the antenna length in the state in which the DC control voltage is not applied, and therefore, an antenna having two resonance frequencies can be formed. If the resonance frequency in the state in which the DC control voltage is not applied and the resonance frequency in the state in which the DC control voltage is applied are assigned to the low frequency range and the high frequency range in the frequency range of the television broadcast signal, respectively, television broadcast signals having a wide frequency range can be received. The circuit formed by the DC applied terminal 51, the chip resistor R44, the chip diode D48, the chip coil L47, the chip antennas ANT42 and ANT43, and the chip capacitors C45 and C46 corresponds to “antenna length selecting means” of the present invention.

The experimental result of radiation characteristics (corresponding to reception characteristics) of the frequency range of a television broadcast signal of the mobile telephone device with a television receiver according to the present embodiment is described next in detail.

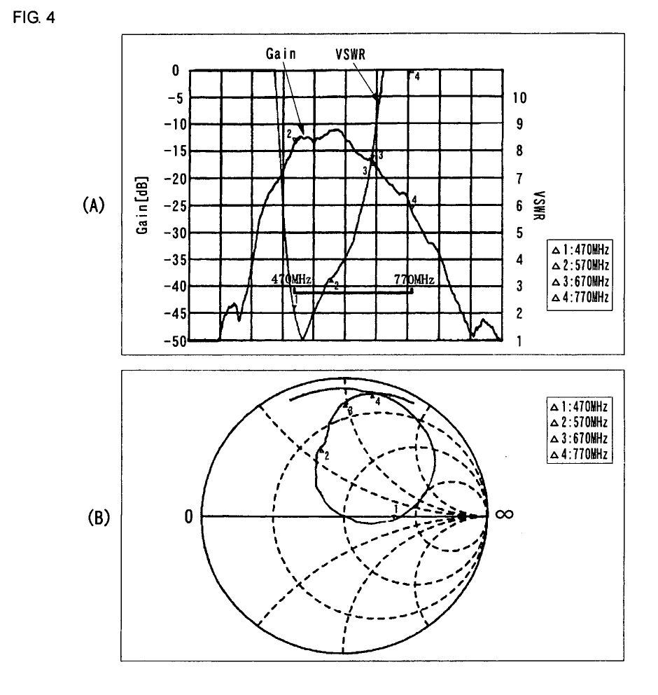

FIG. 4(A) is a graph illustrating the VSWR characteristic and the gain characteristic of the television antenna unit 4 when the chip diode D48 is in an off state, that is, when the antenna length is long. FIG. 4(B) shows the Smith chart in this state.

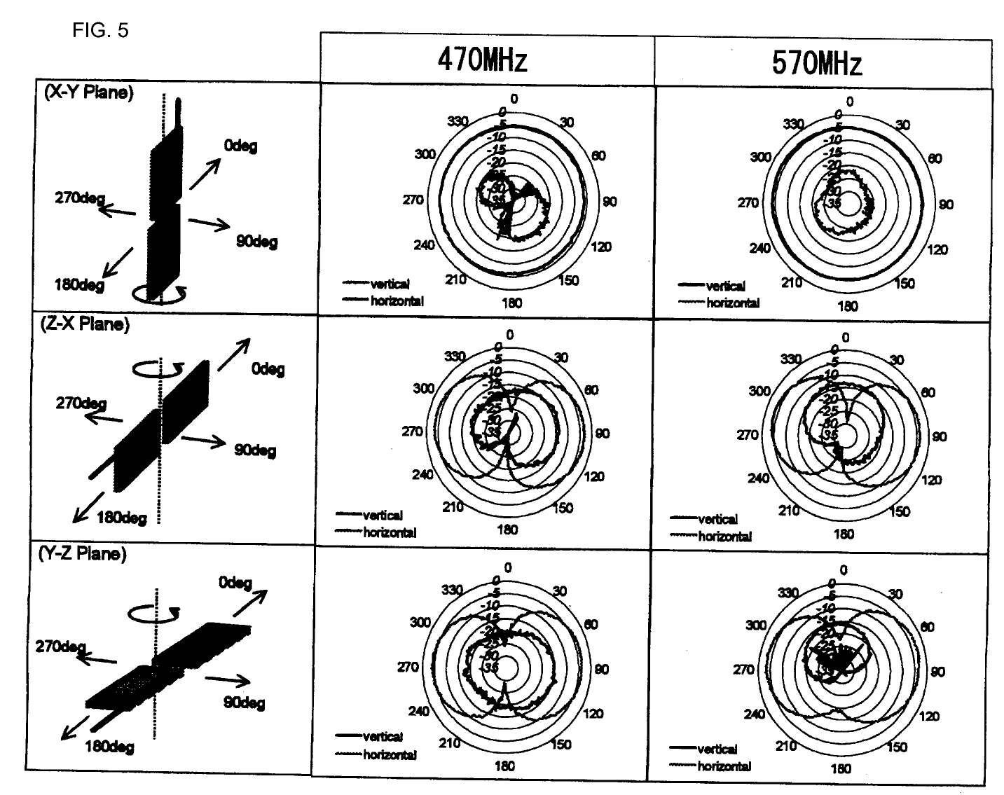

FIG. 5 illustrates the directivity of the radiation electric field strength when the diode D48 is in an off state, wherein the directivities in the in-plane azimuth directions from the mobile telephone device at 470 MHz and at 570 MHz are shown. Table 1 shows maximum gains and average gains for six reference azimuth directions from the mobile telephone device and also shows the radiation efficiency “Effiency” computed on the basis of these values.

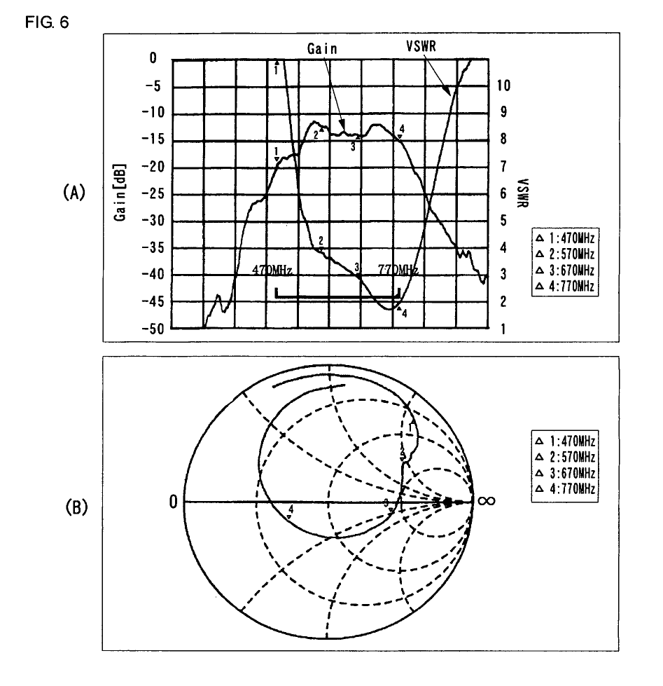

FIG. 6(A) is a graph illustrating the VSWR characteristic and the gain characteristic of the television antenna unit 4 when the diode D48 is in an on state, that is, when the antenna length is short. FIG. 6(B) shows the Smith chart in this state.

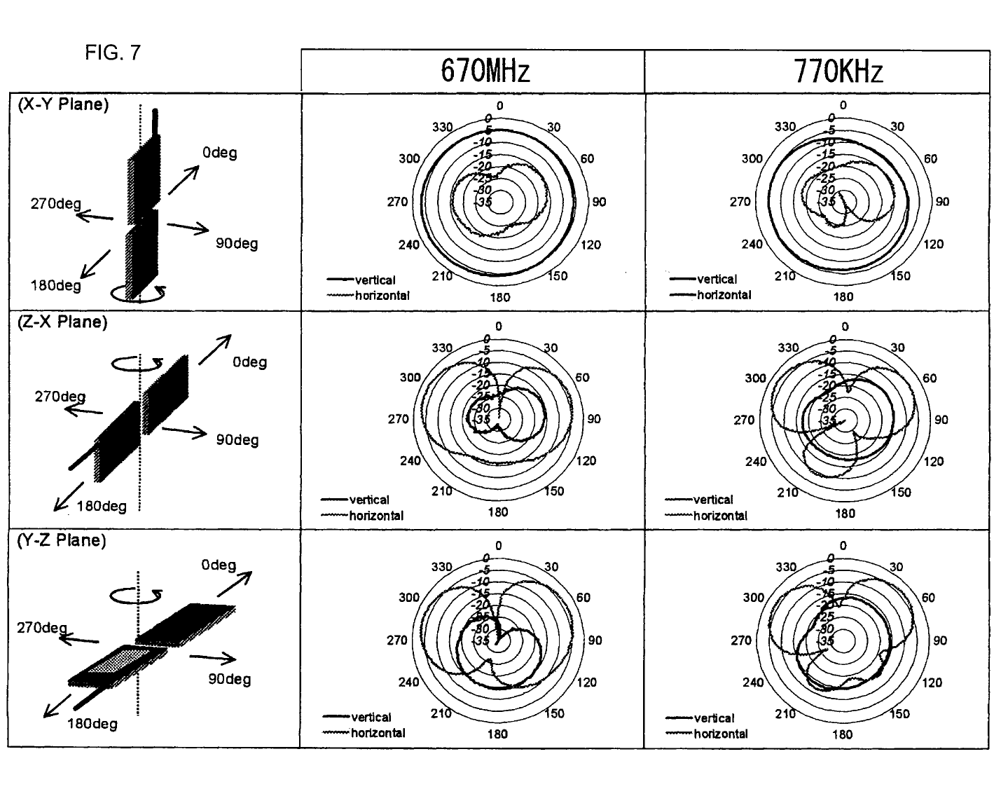

FIG. 7 illustrates the directivity of the radiation electric field strength when the diode D48 is in an on state, wherein the directivities in the in-plane azimuth directions from the mobile telephone device at 670 MHz and at 770 MHz are shown. Table 2 shows maximum gains and average gains for six reference azimuth directions from the mobile telephone device and also shows the radiation efficiency “Effiency” computed on the basis of these values.

Table 3 summarizes these results. That is, Table 3 shows the VSWR characteristic (VSWR Value), the peak gain (Peak Gain) [dBd], and the radiation efficiency (Efficiency) [dB] measured at 470 MHz, 570 MHz, 670 MHz, and 770 MHz.

TABLE 1

Gain [dBd]

| | | | |
|---|---|---|---|
| Plane | polalization | Max | Ave. |

(470 MHz)

| | | | |
|---|---|---|---|
| X-Y | vertical | −4.8 | −5.7 |
| X-Y | horizontal | −17.3 | −22.7 |
| Z-X | vertical | −13.0 | −17.7 |
| Z-X | horizontal | −3.1 | −6.6 |
| Y-Z | vertical | −13.7 | −18.0 |
| Y-Z | horizontal | −3.6 | −7.2 |

| | |
|---|---|
| Efficiency [dB] | −3.1 |

(570 MHz)

| | | | |
|---|---|---|---|
| X-Y | vertical | −3.7 | −4.8 |
| X-Y | horizontal | −20.2 | −23.5 |
| Z-X | vertical | −13.1 | −17.5 |
| Z-X | horizontal | −3.6 | −7.2 |
| Y-Z | vertical | −15.6 | −20.8 |
| Y-Z | horizontal | −2.9 | −6.6 |

| | |
|---|---|
| Efficiency [dB] | −3.3 |

TABLE 2

Gain [dBd]

| | | | |
|---|---|---|---|
| Plane | polalization | Max | Ave. |

(670 MHz)

| | | | |
|---|---|---|---|
| X-Y | vertical | −3.2 | −4.6 |
| X-Y | horizontal | −15.4 | −18.3 |
| Z-X | vertical | −15.5 | −20.8 |
| Z-X | horizontal | −2.7 | −7.1 |
| Y-Z | vertical | −14.1 | −17.8 |
| Y-Z | horizontal | −3.1 | −7.2 |

| | |
|---|---|
| Efficiency [dB] | −3.7 |

(770 MHz)

| | | | |
|---|---|---|---|
| X-Y | vertical | −5.2 | −7.1 |
| X-Y | horizontal | −14.2 | −18.7 |
| Z-X | vertical | −14.7 | −17.1 |
| Z-X | horizontal | −2.8 | −8.3 |
| Y-Z | vertical | −13.7 | −16.1 |
| Y-Z | horizontal | −3.5 | −8.3 |

| | |
|---|---|
| Efficiency [dB] | −4.8 |

TABLE 3

| Measurement | VSWR Value | | | | Peak Gain [dBd] | | | | Efficiency [dB] | | | |
|---|---|---|---|---|---|---|---|---|---|---|---|---|
| Condition | 470M | 570M | 670M | 770M | 470M | 570M | 670M | 770M | 470M | 570M | 670M | 770M |
| Free Space (Open) | 2.6 | 3.1 | 3.3 | 2.3 | −3.1 | −2.9 | −2.7 | −2.8 | −3.1 | 3.3 | −3.7 | −4.8 |

| | | | | | | |
|---|---|---|---|---|---|---|
| Circuit Type | Diode OFF | Diode ON | Diode OFF | Diode ON | Diode OFF | Diode ON |

As noted above, by employing the configuration of a mobile telephone device according to the present embodiment, the VSWR is about 3.0, the peak gain is about −3.0 [dBd], and the radiation efficiency is more than about −5.0 [dB] in the range from 470 MHz to 770 MHz. Accordingly, excellent radiation characteristics can be obtained. That is, a mobile telephone device with a television receiver that can highly efficiently receive television broadcast signals over the entire frequency range of the television broadcast signals can be achieved.

As described above, by employing the configuration according to the present embodiment, the television antenna unit is reliably separated from the mobile telephone device antenna by a predetermined distance. Accordingly, mutual interference between the television broadcast signal reception antenna and the mobile telephone communication signal transmission/reception antenna can be prevented. Thus, a mobile telephone device with a television receiver that can highly efficiently transmit and receive these signals can be achieved.

Furthermore, since the ground electrode that extends along the entire length of the mobile telephone device is connected to the television antenna unit, a mobile telephone device with a television receiver that can efficiently receive the television broadcast signals can be achieved.

Still furthermore, since the effective antenna length of the television antenna unit can be changed, a mobile telephone device with a television receiver that has excellent reception characteristics for the television broadcast signals over a wide frequency range can be achieved.

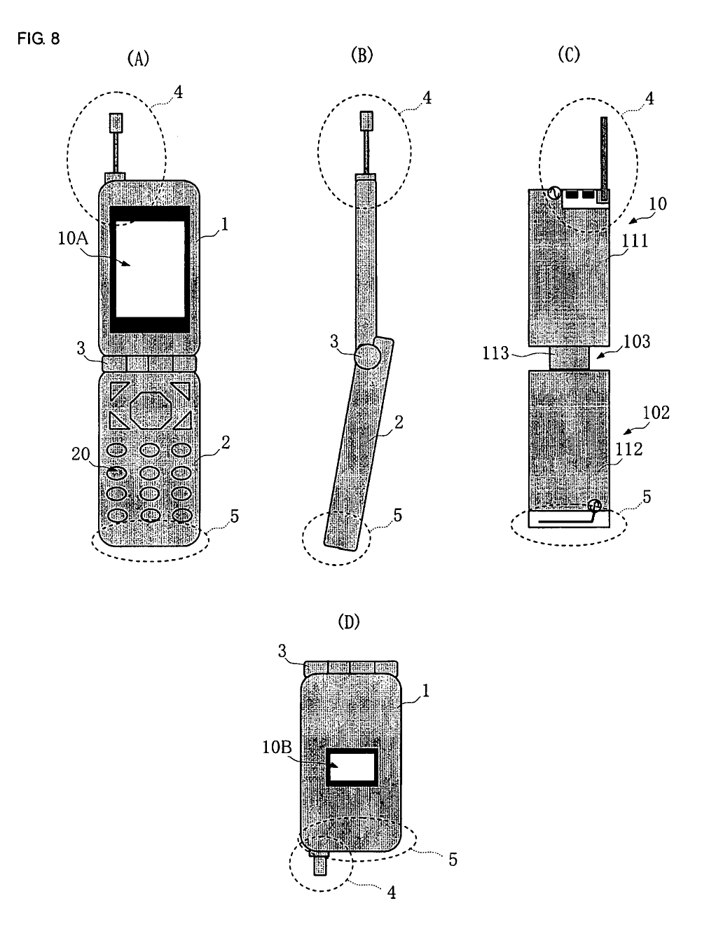

A mobile telephone device with a television receiver according to a second embodiment is described next with reference to FIG. 8.

FIG. 8 is an external view of the mobile telephone device according to the second embodiment, where FIG. 8(A) is a front view when the mobile telephone device is in an open configuration, FIG. 8(B) is a side view when the mobile telephone device is in an open configuration, FIG. 8(C) is a front view of a board in a casing when the mobile telephone device is in an open configuration, and FIG. 8(D) is a front view when the mobile telephone device is in a closed configuration.

As shown in FIG. 8, the mobile telephone device includes a mobile telephone device antenna unit 5 disposed at the end opposite the hinge unit 3 of the operation casing 2. The other structures are similar to those shown in FIG. 1.

In such a structure, when the body is unfolded, the television antenna unit 4 is separated from the mobile telephone device antenna unit 5 by the length of the display casing 1 and the operation casing 2, that is, the length of the mobile telephone device. Accordingly, the distance between these antennas is greater than that of the mobile telephone device of the first embodiment. Consequently, the mutual interference between these antennas is further reduced, and therefore, the mobile telephone device can further efficiently receive the television broadcast signals and can further efficiently transmit and receive the mobile telephone communication signals. In the present embodiment, although the television antenna unit 4 comes close to the mobile telephone device antenna unit 5 when the body is folded, electrical power is not fed to the television antenna unit 4 if the body is folded. Thus, mutual interference between these antennas does not occur.

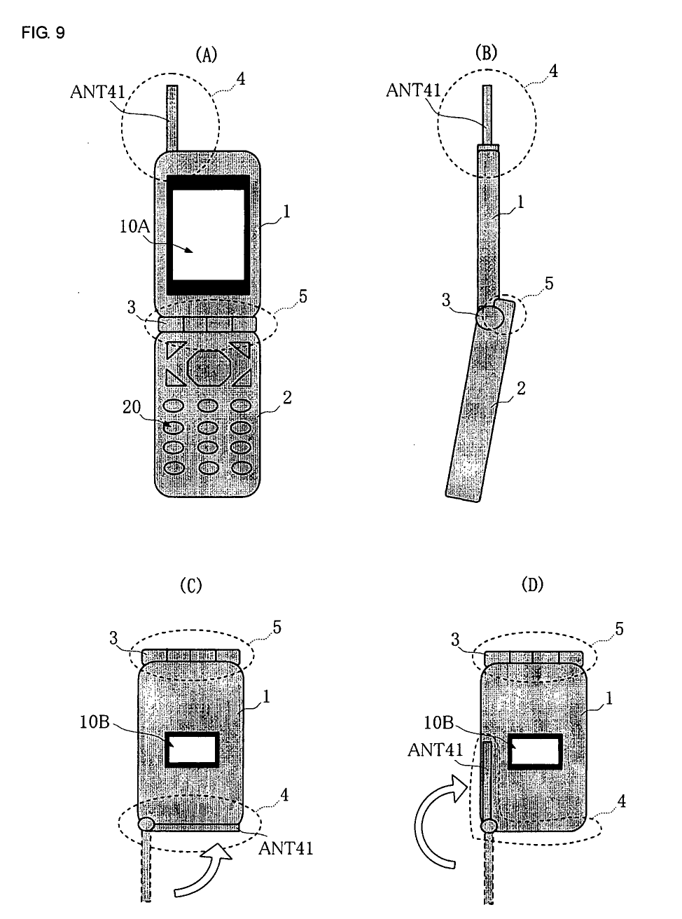

A mobile telephone device with a television receiver according to a third embodiment is described next with reference to FIG. 9.

FIG. 9 is an external view of the mobile telephone device according to the third embodiment, where FIG. 9(A) is a front view when the mobile telephone device is in an open configuration, FIG. 9(B) is a side view when the mobile telephone device is in an open configuration, FIGS. 9(C) and 9(D) are front views when the mobile telephone device is in a closed configuration.

As shown in FIG. 9, the mobile telephone device includes a rod antenna ANT41 of the television antenna unit 4, the rod antenna ANT41 is rotatable with respect to the display casing 1. The other structures are similar to those shown in FIG. 1.

In such a configuration, since the rod antenna ANT41 is disposed so as to be rotatable with respect to the display casing 1, the rod antenna ANT41 can be made to protrude from the display casing 1 in the direction away from the hinge unit 3 when the television broadcast signals are being received. In contrast, when no television broadcast signals are being received, as shown in FIGS. 9(C) and 9(D), the rod antenna ANT41 can be disposed along the end surface of the display casing 1 within the external length of the display casing 1. Thus, a mobile telephone device with a television receiver including the television antenna unit 4 that can efficiently receive the television broadcast signal when being used can be provided. Also, when not being used, the mobile telephone device can maintain the compact size thereof.

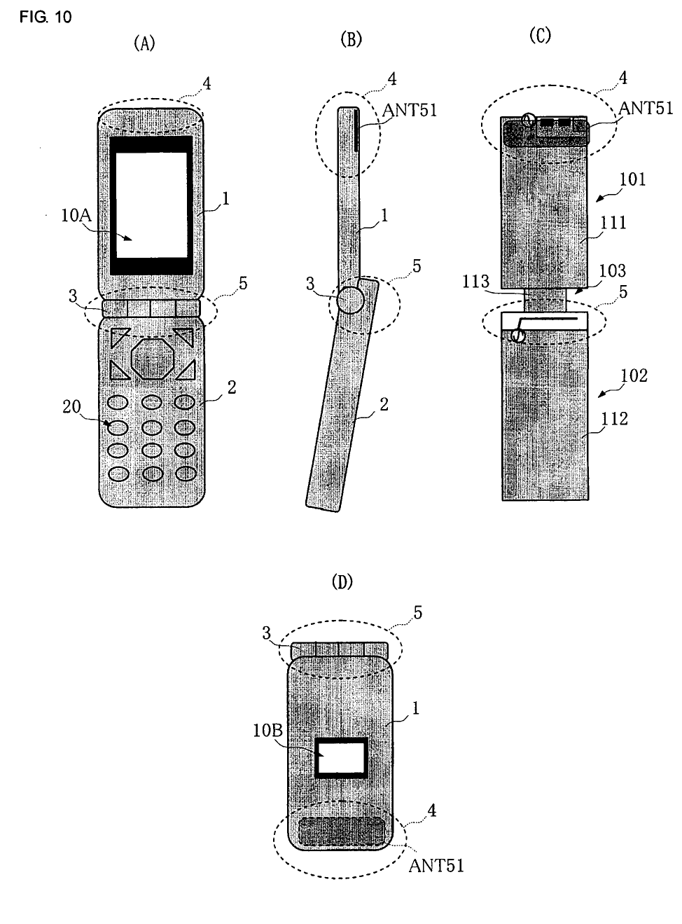

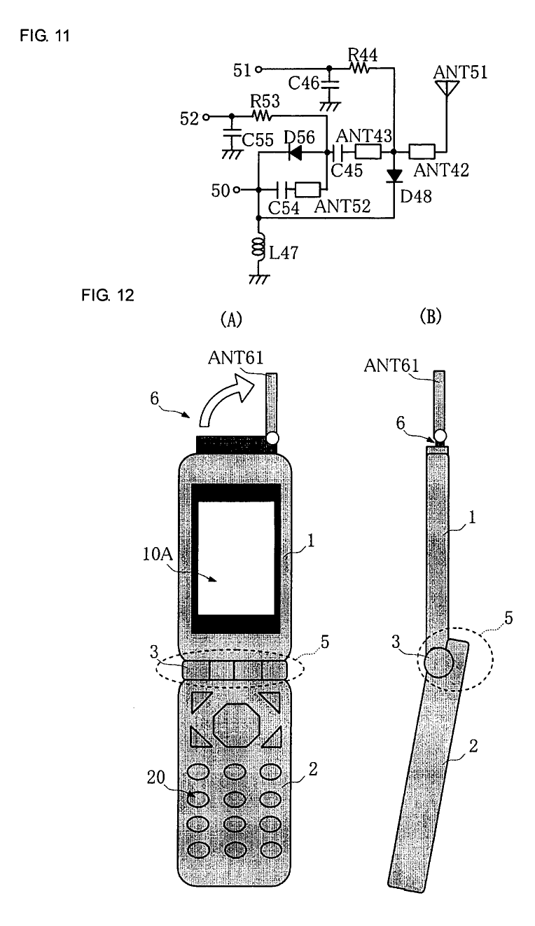

A mobile telephone device with a television receiver according to a fourth embodiment is described next with reference to FIGS. 10 and 11.

FIG. 10 is an external view of the mobile telephone device according to the fourth embodiment, where FIG. 10(A) is a front view when the mobile telephone device is in an open configuration, FIG. 10(B) is a side view when the mobile telephone device is in an open configuration, FIG. 10(C) is a front view of a board in a casing when the mobile telephone device is in an open configuration, and FIG. 10(D) is a front view when the mobile telephone device is in a closed configuration.

FIG. 11 is a circuit diagram of the television antenna unit 4 according to the fourth embodiment.

As shown in FIG. 10, the mobile telephone device includes a television antenna unit 4 having a different configuration. The other structures are similar to those of the mobile telephone device shown in FIG. 1.

More specifically, in place of the rod antenna ANT41 of the television antenna unit 4, a plate antenna ANT51 bonded to the inner surface of the display casing 1 is disposed. One end of the plate antenna ANT51 is connected to one end of the chip antenna ANT42. Additionally, a parallel circuit of a chip diode D56 and a series circuit of a chip antenna ANT52 and a chip capacitor C54 is connected between the feed point 50 and the chip capacitor C45 connected to the chip antenna ANT43. The connection point between the parallel circuit and the chip capacitor C45 is connected, via a chip resistor R53, to a second DC applied terminal 52 connected to the ground electrode 111 using a chip capacitor C55. By controlling a combination of DC control voltages applied to the DC applied terminals 51 and 52, three different lengths of the antenna can be selectively achieved. More specifically, when only the plate antenna ANT51 and the chip antenna ANT42 function as the antenna, a mode in which the antenna length is the minimum can be provided. When the plate antenna ANT51 and the chip antennas ANT42 and ANT43 function as the antenna, a mode in which the antenna length is of an intermediate value can be provided. When all the antennas, that is, the plate antenna ANT51, the chip antennas ANT42 and ANT43, and the chip antenna ANT52 function as the antenna, a mode in which the antenna length is the maximum can be provided.

In this way, by replacing the rod antenna with the plate antenna formed in the display casing, the television antenna unit 4 does not extend beyond the casing at all. Thus, the dimensions of the mobile telephone device can be reduced even when the television broadcast signals are being received. At that time, the radiation characteristic of the plate antenna deteriorates, compared with a rod antenna that protrudes outwardly. However, by dividing, as noted above, the setting of the antenna length, impedance matching of the antenna can be finely adjusted so that the above-described deterioration can be reduced. In this case, since the plate antenna ANT51 is bonded to the inner surface of the display casing 1, the chip antennas ANT42, ANT43, and ANT52 can be mounted on the surface of the board 101 facing the inner surface of the display casing 1. As a result, a compact mobile telephone device that can efficiently receive the television broadcast signals can be achieved.

A mobile telephone device with a television receiver according to a fifth embodiment is described next with reference to FIG. 12.

FIG. 12 is an external view of the mobile telephone device according to the fifth embodiment, where FIG. 12(A) is a front view when the mobile telephone device is in an open configuration and FIG. 12(B) is a side view when the mobile telephone device is in an open configuration.

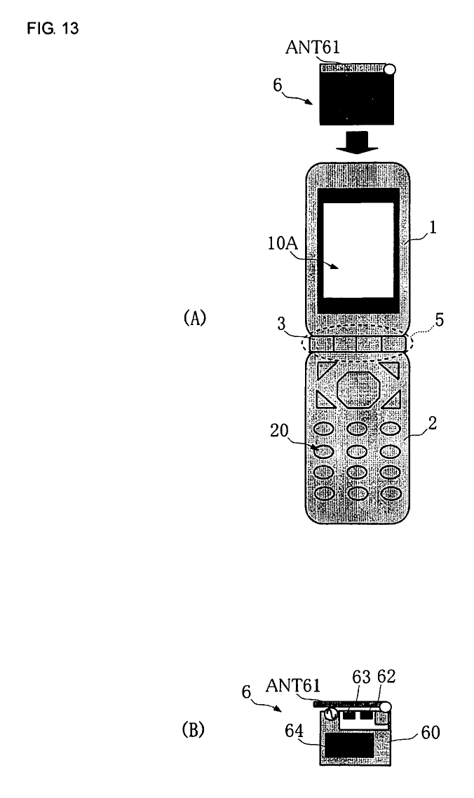

FIG. 13(A) is an exploded view illustrating the structure of the mobile telephone device according to the fifth embodiment. FIG. 13(B) is a plan view of a television antenna member 6 of the mobile telephone device.

As shown in FIGS. 12 and 13, the mobile telephone device with a television receiver includes the removable television antenna member 6 that is a replacement of the television antenna unit 4 shown in the first embodiment. The other structures are similar to those of the mobile telephone device with a television receiver shown in FIG. 1.

The television antenna member 6 includes a rod antenna ANT61, chip antennas ANT62 and ANT63, and a tuner circuit 64 mounted on a board 60. The television antenna member 6 includes a circuit similar to the antenna circuit shown in FIG. 2, in which the rod antenna 61 corresponds to the rod antenna ANT41 shown in FIG. 2 and the chip antennas ANT62 and ANT63 correspond to the chip antennas ANT42 and ANT43 shown in FIG. 2, respectively. A feed point of this circuit is connected to the tuner circuit 64.

Even such a configuration can provide advantages that are the same as those of the first embodiment. In addition, the television antenna member 6 can be attached only when the television broadcast signals are being received. Accordingly, only the mobile telephone device communication antenna is disposed when mobile telephone communication signals are being transmitted and received. Consequently, mutual interference does not occur, and therefore, the mobile telephone device can further efficiently transmit and receive the mobile telephone communication signals.

The foregoing embodiments have been described with reference to a television broadcast signal as a signal in the first frequency range and a mobile telephone communication signal as a signal in the second frequency range that is higher than the first frequency range. However, the above-described configuration is applicable to an apparatus if the frequencies of two signals received by the apparatus are different so that the above-described advantages can be provided.

1. A foldable mobile telephone device comprising:
a first casing including a display;
a second casing including an operation unit;
a hinge rotatably connecting the first casing to the second casing;
a first antenna mounted at an end of the first casing opposite to the hinge, the first antenna receiving a signal in a first frequency range;
a second antenna mounted on the second casing, the second antenna transmitting and receiving a signal in a second frequency range that is higher than the first frequency range; and
a ground electrode continuously extending from the end of the first casing opposite the hinge to an end of the second casing opposite to the hinge.

2. The mobile telephone device according to claim 1, wherein the signal in the first frequency range includes a television broadcast signal and the signal in the second frequency range includes a mobile telephone communication signal and wherein the second antenna transmits and receives the mobile telephone communication signal.

3. The mobile telephone device according to claim 1, wherein the first antenna includes a linear conductor antenna outwardly extending from the end of the first casing and a chip antenna disposed inside the first casing and electrically communicating with the linear conductor antenna.

4. The mobile telephone device according to claim 3, wherein the linear conductor antenna is rotatably mounted on the first casing.

5. The mobile telephone device according to claim 1, wherein the first antenna includes a plate conductor antenna disposed inside the first casing and a chip antenna electrically communicating with the plate conductor antenna.

6. The mobile telephone device according to claim 5, wherein the plate conductor antenna is bonded to an inner surface of the first casing.

7. The mobile telephone device according to claim 1, wherein the first antenna includes an antenna length selector that selectively changes an effective antenna length.

8. The mobile telephone device according to claim 1, wherein the first antenna is removably disposed on the first casing.

9. The mobile telephone device according claim 1, wherein the second antenna is disposed at an end of the second casing proximal to the hinge.

10. The mobile telephone device according to claim 1, wherein the second antenna is disposed at the end of the second casing opposite the hinge.

11. The mobile telephone device according to claim 3, wherein the chip antenna includes:
a base formed from at least one of a dielectric material and a magnetic material;
a power feeding conductor formed at least one of in the base and on the base; and
a power feeding terminal for feeding electric power to the power feeding conductor.

12. The mobile telephone device according to claim 7, wherein the antenna length selector includes a switching element connected between a first end of the chip antenna and a signal output unit and a passive component connected between a second end of the chip antenna and the signal output unit.

13. The mobile telephone device according to claim 12, wherein the passive component comprises one of an inductor and a capacitor.

14. The mobile telephone device according to claim 5, wherein the chip antenna includes:
a base formed from at least one of a dielectric material and a magnetic material;
a power feeding conductor formed at least one of in the base and on the base; and
a power feeding terminal for feeding electric power to the power feeding conductor.
